(19) United States
(12) Patent Application Publication
(10) Pub. No.: US 2005/0162406 A1
(43) Pub. Date: Jul. 28, 2005

(54) Positional information outputting device, positional information outputting method, and signal processing method

(75) Inventors: Kenichiro Ono, Kanagawa-ken (JP); Takashi Tsunoda, Kanagawa-ken (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/032,115

(22) Filed: Jan. 11, 2005

(30) Foreign Application Priority Data
Jan. 23, 2004 (JP) 2004-015613

(51) Int. Cl. G09G 5/00

(52) U.S. Cl. 345/173

(57) ABSTRACT

A positional information outputting device comprising: a display screen; a positional information outputting circuit for outputting the coordinate information of a position designated on the display screen; and an output circuit for outputting a display signal for displaying a first image corresponding to a portion of an image, which can be formed with an image signal inputted, on a first area and a second area of the display screen. The positional information outputting circuit outputs, in case the inside of the first area on the display screen is designated, the coordinate information on the designated position, but converts, in case the inside of the second area is designated, the coordinate information on the designated position into the coordinate information on the corresponding position in the first area, and outputs the converted coordinate information.

### BACKGROUND OF THE INVENTION

1. Field of the Invention

The present invention relates to a positional information outputting device, which is combined with a display device and position detecting means such as a touch panel or a pen.

2. Description of the Related Art

As the display device such as a large-sized flat display, there have been heretofore practiced various types such as a liquid crystal type or a plasma type, which have been extended in their application ranges to not only the home TV but also presentations at offices.

When the display device is applied to preliminary arrangements or collaboration systems involving several persons in the office, on the other hand, editing operations are indispensable so that the display has to be combined position detecting means such as the touch panel or pen for designating a position on the display screen.

Thus, it is expected that conveniences are further increased, if a single display device can split its screen and can display identical contents in a face-to-face relation so that the displayed contents can be simultaneously confirmed by an operator and a facing person.

This split face-to-face display device is disclosed in Patent Publication 1. Moreover, a display system, in which a position in a split display device can be designated with a pen, is disclosed in Patent Publication 2.
Patent Publication 1: JP-A-05-197507
Patent Publication 2: JP-A-2001-175376

### SUMMARY OF THE INVENTION

Let the scene (FIG. 2) be assumed, in which a clerk and a customer are seated in a face-to-face positional relation across a display device held in a horizontal position and a touch panel attached to the display device. In FIG. 2: numeral 1 designates a clerk; numeral 2 designates a customer; and an table-shaped article between them is a composite of the display device 22 and the touch panel 24 placed horizontally.

In this scene, the clerk 1 is preparing a written estimate, and the same estimate is displayed in the other split face by the split face-to-face display. The image data are shown in FIG. 3 and are displayed in a split face-to-face relation, as shown in FIG. 4.

Here, the screen area for the clerk 1 to alter the contents of the estimate is called a first area 35, and the screen area being observed by the customer 2 is called a second area 36.

When the customer 2 does an input to the second area 36 via the touch panel 24, what is actually displayed is the second area 36 in the split face-to-face display. However, the input of the touch panel 24 is done on a [B] screen 32. Therefore, the customer 2 reacts with the [B] screen 32 thereby to raise a problem that the action is an unintentional one. Here is enumerated the case, in which the two identical screens are displayed in different directions of 180 degrees. However, similar problems also occur even in case the display directions are made different other than 180 degrees or made identical.

An object of the invention is to provide a configuration, which can avoid an unintentional positional information input.

According to an aspect of the invention, there is provided a positional information outputting device comprising: a display screen; a positional information outputting circuit for outputting the coordinate information of a position designated on the display screen; and an output circuit for outputting a display signal for displaying a first image corresponding to a portion of an image, which can be formed with an image signal inputted, on a first area and a second area of the display screen, wherein the positional information outputting circuit outputs, in case the inside of the first area on the display screen is designated, the coordinate information on the designated position, and converts, in case the inside of the second area is designated, the coordinate information on the designated position into the coordinate information on the corresponding position in the first area, and outputs the converted coordinate information.

According to another aspect of the invention, there is provided a positional information outputting device comprising: a display screen; a positional information outputting circuit for outputting the coordinate information of a position designated on the display screen; an output circuit for outputting a display signal for displaying a first image corresponding to a portion of an image, which can be formed with an image signal inputted, on a first area and a second area of the display screen; and a control circuit for performing, in case the coordinate information outputted by the positional information outputting circuit is the information indicating that the inside of the first area on the display screen is designated, a predetermined signal processing according to the coordinate information, and for converting, in case the coordinate information outputted by the positional information outputting circuit is the information indicating that the inside of the second area on the display screen is designated, the coordinate information into the coordinate information on the corresponding position in the first area thereby to perform the predetermined signal processing.

According to still another aspect of the invention, there is provided a positional information outputting method for a positional information outputting device including: a display screen; a positional information outputting circuit for outputting the information of a position designated on the display screen; and an output circuit for outputting a display signal for displaying a first image corresponding to a portion of an image, which can be formed with an image signal inputted, on a first area and a second area of the display screen, wherein the positional information outputting circuit outputs, in case the inside of the first area on the display screen is designated, the coordinate information on the designated position, and converts, in case the inside of the second area is designated, the coordinate information on the designated position into the coordinate information on the corresponding position in the first area, and outputs the converted coordinate information.

According to a further aspect of the invention, there is provided a signal processing method for performing a signal processing according to the coordinate information outputted by a positional information outputting device including: a display screen; a positional information outputting circuit for outputting the coordinate information of a position designated on the display screen; and an output circuit for outputting a display signal for displaying a first image corresponding to a portion of an image, which can be formed with an image signal inputted, on a first area and a second area of the display screen, wherein in case the coordinate information outputted by the positional information outputting circuit is the information indicating that the inside of the first area on the display screen is designated, a predetermined signal processing according to the coordinate information is performed, and wherein in case the coordinate information outputted by the positional information outputting circuit is the information indicating that the inside of the second area on the display screen is designated, the coordinate information is converted into the coordinate information of the corresponding position in the first area, and the predetermined signal processing is performed.

According to a further aspect of the invention, there is provided a positional information outputting device comprising: a display screen; a positional information outputting circuit for outputting the coordinate information of a position designated on the display screen; and an output circuit for outputting a display signal for displaying a first image corresponding to a portion of an image, which can be formed with an image signal inputted, on a first area and a second area of the display screen, wherein the positional information outputting circuit outputs, in case the inside of the first area on the display screen is designated, the coordinate information on the designated position, and converts, in case the inside of the second area is designated, the coordinate information on the designated position into the coordinate information on the corresponding position in the first area, and outputs the converted coordinate information, but does not output, in case either the inside of the area defined by the first area and the second area or the inside of a predetermined area adjoining the boundary between the first area and the second area is designated, the coordinate information on the designated position.

According to a further aspect of the invention, there is provided a positional information outputting device comprising: a display screen; a positional information outputting circuit for outputting the coordinate information of a position designated on the display screen; an output circuit for outputting a display signal for displaying a first image corresponding to a portion of an image, which can be formed with an image signal inputted, on a first area and a second area of the display screen; and a control circuit for performing, in case the coordinate information outputted by the positional information outputting circuit is the information indicating that the inside of the first area on the display screen is designated, a predetermined signal processing according to the coordinate information, and for converting, in case the coordinate information outputted by the positional information outputting circuit is the information indicating that the inside of the second area on the display screen is designated, the coordinate information into the coordinate information on the corresponding position in the first area thereby to perform the predetermined signal processing, but for unperforming, in case the coordinate information outputted by the positional information outputting circuit is the information indicating either the inside of the area defined by the first area and the second area or the inside of a predetermined area adjoining the boundary between the first area and the second area, the predetermined signal processing according to the coordinate information.

According to a further aspect of the invention, there is provided a positional information outputting method for a positional information outputting device including: a display screen; a positional information outputting circuit for outputting the information of a position designated on the display screen; and an output circuit for outputting a display signal for displaying a first image corresponding to a portion of an image, which can be formed with an image signal inputted, on a first area and a second area of the display screen, wherein the positional information outputting circuit outputs, in case the inside of the first area on the display screen is designated, the coordinate information on the designated position, and converts, in case the inside of the second area is designated, the coordinate information on the designated position into the coordinate information on the corresponding position in the first area, and outputs the converted coordinate information, but does not output, in case either the inside of the area defined by the first area and the second area or the inside of a predetermined area adjoining the boundary between the first area and the second area is designated, the coordinate information on the designated position.

According to a further aspect of the invention, there is provided a signal processing method for performing a signal processing according to the coordinate information outputted by a positional information outputting device including: a display screen; a positional information outputting circuit for outputting the coordinate information of a position designated on the display screen; and an output circuit for outputting a display signal for displaying a first image corresponding to a portion of an image, which can be formed with an image signal inputted, on a first area and a second area of the display screen, wherein in, case the coordinate information outputted by the positional information outputting circuit is the information indicating that the inside of the first area on the display screen is designated, a predetermined signal processing according to the coordinate information is performed, and wherein in case the coordinate information outputted by the positional information outputting circuit is the information indicating that the inside of the second area on the display screen is designated, the coordinate information is converted into the coordinate information of the corresponding position in the first area, and the predetermined signal processing is performed, and wherein in case the coordinate information outputted by the positional information outputting circuit is the information indicating either the inside of the area defined by the first area and the second area or the inside of a predetermined area adjoining the boundary between the first area and the second area, the predetermined signal processing according to the coordinate information is not performed.

According to a further object of the invention, there is provided a positional information outputting device comprising: a display screen; a positional information outputting circuit for outputting the coordinate information of a position designated on the display screen; an output circuit for outputting a display signal for displaying a first image corresponding to a portion of an image, which can be formed with an image signal inputted, on a first area and a second area of the display screen; and a control circuit for performing, in case the coordinate information outputted by the positional information outputting circuit is the information indicating that the inside of the first area on the display screen is designated, a predetermined signal processing according to the coordinate information, and for converting, in case the coordinate information outputted by the positional information outputting circuit is the information indicating that the inside of the second area on the display screen is designated, the coordinate information into the coordinate information on the corresponding position in the first area thereby to perform the predetermined signal processing, but for inhibiting, in case the coordinate information outputted by the positional information outputting circuit is the information indicating either the inside of the area defined by the first area and the second area or the inside of a predetermined area adjoining the boundary between the first area and the second area, the predetermined signal processing according to the coordinate information.

According to a further aspect of the invention, there is provided a signal processing method for performing a signal processing according to the coordinate information outputted by a positional information outputting device including: a display screen; a positional information outputting circuit for outputting the coordinate information of a position designated on the display screen; and an output circuit for outputting a display signal for displaying a first image corresponding to a portion of an image, which can be formed with an image signal inputted, on a first area and a second area of the display screen, wherein in case the coordinate information outputted by the positional information outputting circuit is the information indicating that the inside of the first area on the display screen is designated, a predetermined signal processing according to the coordinate information is performed, and wherein in case the coordinate information outputted by the positional information outputting circuit is the information indicating that the inside of the second area on the display screen is designated, the coordinate information is converted into the coordinate information of the corresponding position in the first area, and the predetermined signal processing is performed, and wherein in case the coordinate information outputted by the positional information outputting circuit is the information indicating either the inside of the area defined by the first area and the second area or the inside of a predetermined area adjoining the boundary between the first area and the second area, the predetermined signal processing according to the coordinate information is inhibited.

The invention can prevent an unintentional operation.

### BRIEF DESCRIPTION OF THE DRAWINGS

FIG. 1 is a configuration diagram of a display system according to a first embodiment;

FIG. 2 is a diagram showing the situation, in which the display system according to the first embodiment is used;

FIG. 3 shows an example of a screen taken from a display generation unit of the display system according to the first embodiment;

FIG. 4 is a screen example of the display system according to the first embodiment;

FIG. 5 is an example of coordinates of a touch panel of the display system according to the first embodiment;

FIG. 6 is a flow chart of the display system according to the first embodiment; and

FIG. 7 is an explanatory view showing a drawback in the first embodiment;

FIG. 8 is a screen example of a display system according to a second embodiment;

FIG. 9 is a flow chart of a display system according to the second embodiment.

### DETAILED DESCRIPTION OF THE PREFERRED EMBODIMENTS

The best mode of embodiment of the invention will be illustratively described in detail with reference to the accompanying drawings. However, the sizes, materials, shapes and relative arrangements of the components described in the embodiments are not intended to be limited by the components described, so long as they are not specifically described. Moreover, the display direction at the time when an identical screen is displayed in a plurality of areas will be exemplified as an especially preferable example by a facing display, but the example should not be limited to the facing display. The display can be set in various directions including a display of an identical direction. However, the invention can be preferably applied especially to the case, in which a plurality of identical screens are display in different display directions.

### First Embodiment

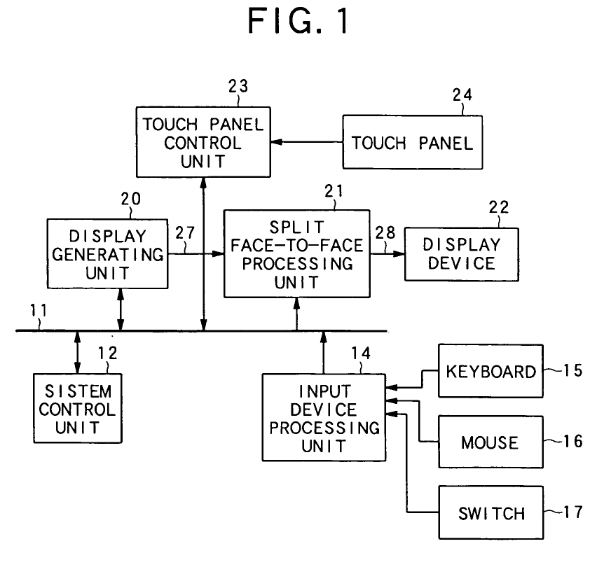

The first embodiment will be described with reference to FIG. 1 to FIG. 6. FIG. 1 shows a configuration diagram of a display system according to the first embodiment.

In FIG. 1, reference numeral 11 designates a bus, with which the individual blocks are connected. Numeral 12 designates a system control unit controlling the entire system and corresponding to a control circuit. The system control unit 12 includes a CPU and a memory.

Numeral 15 designates a keyboard, and numeral 16 designates a mouse. Numeral 17 designates a switch for setting a display mode, by which a user switches an entire display and a split face-to-face display. An input device processing unit 14 transmits pieces of information from the individual input devices to the system control unit 12 via the bus 11. Knowing the display mode being set, the system control unit 12 sets the display mode in a split face-to-face processing unit 21 and a touch panel control unit 23.

Numeral 20 designates a display generating unit for generating the contents to be displayed in response to the instruction of the system control unit 12. The numeral 21 designates the split face-to-face processing unit corresponding to an output circuit, and its role will be described hereinafter. Numeral 22 designates a display device having a display screen which displays display data. The numeral 23 designates the touch panel control unit for transmitting positional information from a touch panel 24 via the bus 11 to the system control unit 12. The numeral 24 designates the touch panel for detecting the position designated by the user, as the positional information. This touch panel 24 can employ the well-known configuration such as the ultrasonic surface elastic wave type, the resistive film type, the electrostatic capacity type or the infrared scanning type. The touch panel 24 and the touch panel control unit 23 correspond to a positional information outputting circuit.

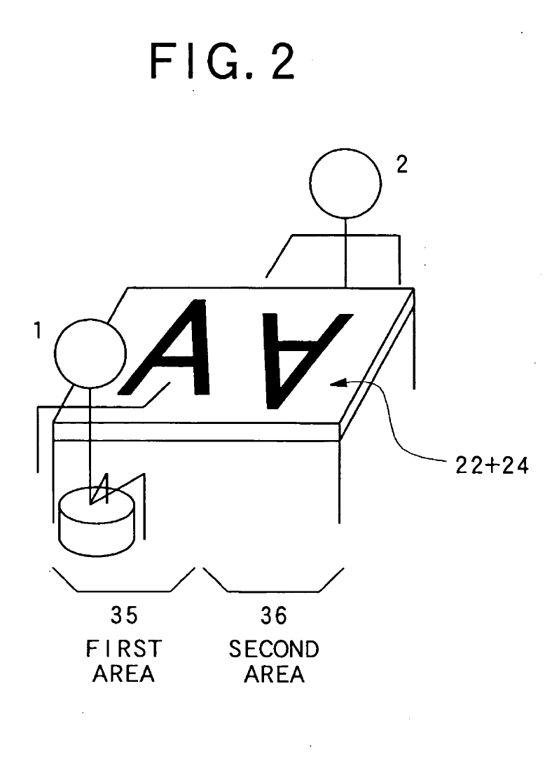

Let the case (FIG. 2) be assumed, for example, in which a clerk and a customer facing each other are seated across the display device placed horizontally and the touch panel attached to the display device. In FIG. 2: numeral 1 designates a clerk; numeral 2 designates a customer; and an table-shaped article between them is a composite of the display device 22 and the touch panel 24 placed horizontally.

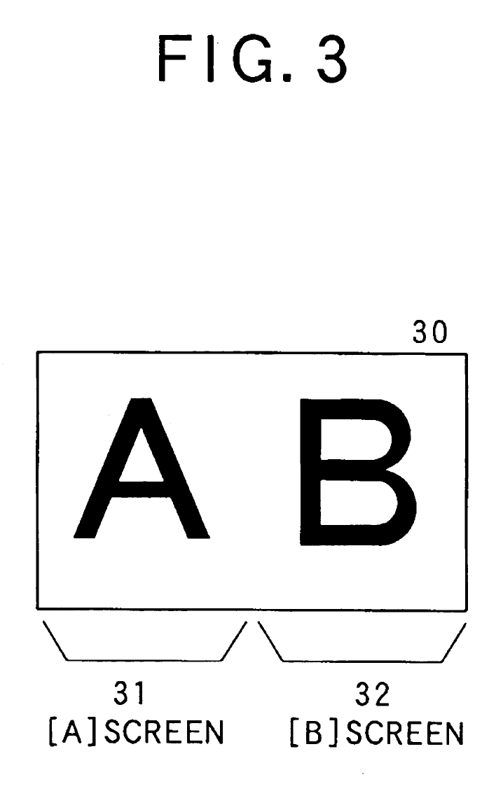

It is also assumed that the display generating unit 20 generates the contents, as shown in FIG. 3, in response to the instruction from the system control unit 12. Here are further assumed that an [A] screen 31 is generated on the left half whereas a [B] screen 32 is generated on the right half. These contents are transmitted to the split face-to-face processing unit 21 via a signal line 27 as the output of the display generating unit 20.

When the display mode is set from the system control unit 12 so that the entire screen display mode is recognized, the split face-to-face processing unit 21 feeds the display data from the display generating unit 20 as they are to a signal line 28. When the split face-to-face display mode is recognized, the display is split into just left and right halves. The [A] screen 31 or the left half of the display data from the display generating unit 20 is used as it is as the left half display data, and the [A] screen 31 is turned 180 degrees into the right half display data. By this processing, there can be outputted display signals for displaying a first image (corresponding to the left half of FIG. 3) corresponding to a portion of the image (FIG. 3), which can be formed with the image signals inputted from the display generating unit 20, simultaneously on the display area on the left screen side or the first area and on the display area on the right screen side or the second area. Here, the display area on the screen left side is assumed as an active area, whereas the display area on the screen right side is assumed as an inactive area. The entire display area need not be assigned to the first area and the second area. There may be another area having no overlap with the first area and the second area.

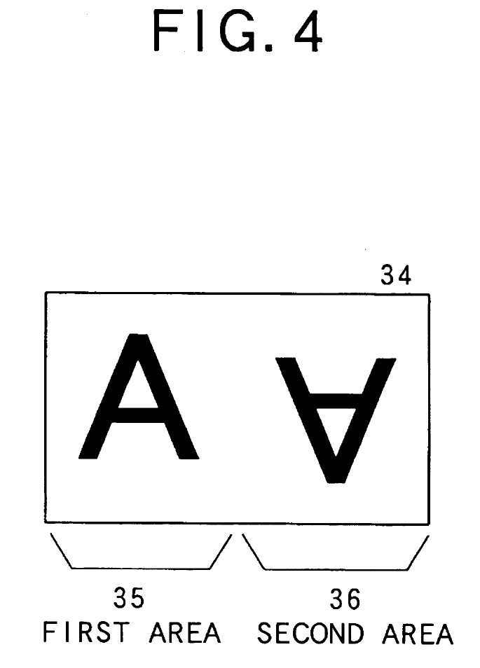

The behavior of the output signals of the signal line 28 from the split face-to-face processing unit 21 is shown in FIG. 4. Here, the [A] screen on the left half is used as it is for a first area 35 and is turned 180 degrees on the right half to synthesize a second area 36, and the two screens are displayed in the display device 22.

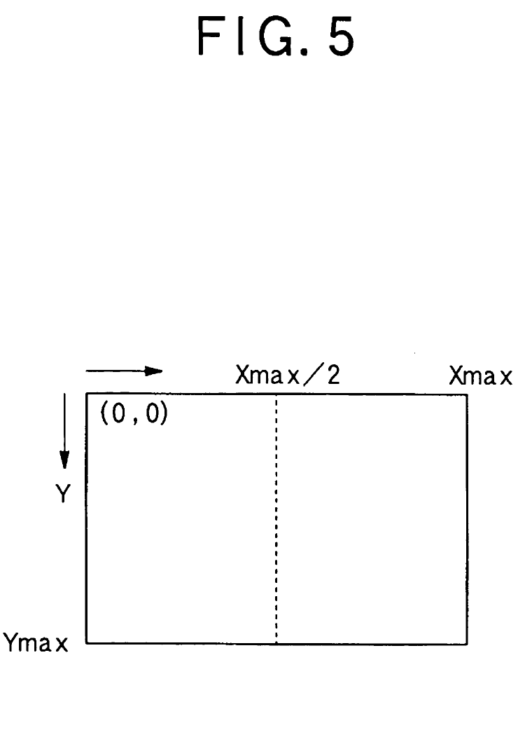

The touch panel 24 has its input coordinate position corresponding to the display area of the display device 22, and outputs the coordinate position of a displayed point when this point is touched. As shown in FIG. 5, a left upper coordinate is expressed with an XY coordinate system by (0, 0) and a right lower coordinate is expressed by (Xmax, Ymax). The positional information at the time when the user touches the touch panel 24 is transmitted to the touch panel control unit 23. Here, the X-coordinate and the Y-coordinate designated by the user are assumed as X and Y, respectively.

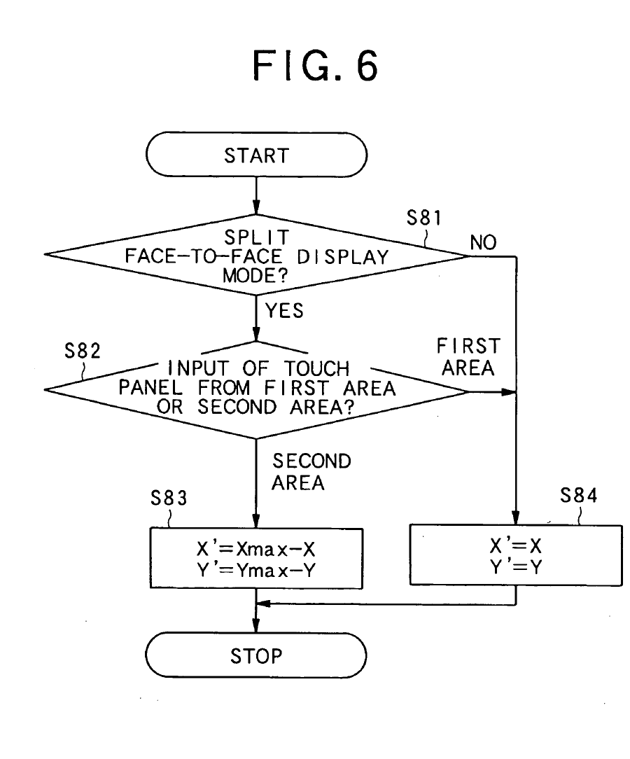

The processing method at this time will be described with reference to the flow chart of FIG. 6. The touch panel control unit 23 is informed of the display mode and decides (S81) whether or not the mode is the split face-to-face display mode. The routine advances to S82 if yes but to S84 if no.

At S82, it is decided whether the input from the touch panel 24 belongs to the first area or the second area. Specifically, the decision can be made depending on whether or not the inputted X-coordinate is larger than Xmax/2, such that the X-coordinate belongs to the second area in the larger case but to the first area in the smaller case. The routine advances to S83, if to the second area, but to S84 if to the first area.

At S83, the input coordinate X from the touch panel 24 is converted into a coordinate on the [A] screen of the left half.

Namely,
X′=Xmax−X.

Likewise, the input coordinate Y from the touch panel 24 is converted into a coordinate on the [A] screen of the left half.

Namely,
Y′=Ymax−Y.

At S84, the input coordinates X and Y from the touch panel 24 are outputted as they are.

Namely,
X′=X,
and
Y′=Y.

In summary, for the touch panel input coordinates (X, Y), the output coordinates (X′, Y′) from the touch panel control unit 23 are, as follows:
1) In the case of the split face-to-face display mode,
a) 0≦X≦Xmax/2 (the left half),
   X′=X,
   and
   Y′=Y; and
b) Xmax/2<X≦Xmax (the right half),
   X′=Xmax−X,
   and
   Y′=Ymax−Y.
2) In the case of the full screen display,
   X′=X,
   and
   T′=Y.

Thus, in the split face-to-face display mode, the designation of the right half in the second area 36 can be properly reflected on the display screen so that the unintentional operation can be prevented.

In the mode thus far described, the value of the X-coordinate inputted in the split face-to-face display mode from the touch panel 24 by the touch panel control unit 23 is discriminated to change the output coordinates. Specifically, the output coordinate information is converted in the positional information outputting circuit. In this processing, however, when a predetermined signal processing based on the coordinate information is to be performed not in the touch panel control unit 23 but in the system control unit 12 or another circuit, the unconverted coordinate information from the positional information outputting circuit is converted in the circuit for the signal processing before the signal processing. With another configuration, in case it is recognized that the position in the second area is indicated when the mode is in the split face-to-face display mode, the coordinate information is outputted like the aforementioned mode from the positional information outputting circuit, a signal may be outputted by adding to it the information for performing, after the conversion of the coordinate information, the predetermined signal processing using the signal containing that coordinate information. Here, the signal processing based on the coordinate information can be exemplified by the signal processing for displaying a pointer symbol (in an arrow shape) at a position corresponding to the coordinate information on the basis of the same coordinate information.

In the aforementioned mode, on the other hand, the left [A] screen is used as the first area so that the positional information from the coordinates of the area of the [B] screen is converted into the coordinates of the first area of the [A] screen. In another processing, on the contrary, the right [B] screen may be used as the first area and displayed in the face-to-face relation so that the positional information from the coordinate in the area of the [A] screen is converted into the coordinates of the first area of the [B] screen.

In the mode thus far described, moreover, the positional information outputting device adopts the configuration having the touch panel, but can attain similar effects by a similar processing with a pointing device such as a mouse or a pen. As the configuration for designating the position on the screen, there can be used one other than that, in which a finger or a designating member such as one having a pen shape is brought to contact or close to the screen. However, it is desired to use the configuration, in which the finger or the designating member such as one having the pen shape contacts or comes close to the screen.

### Second Embodiment

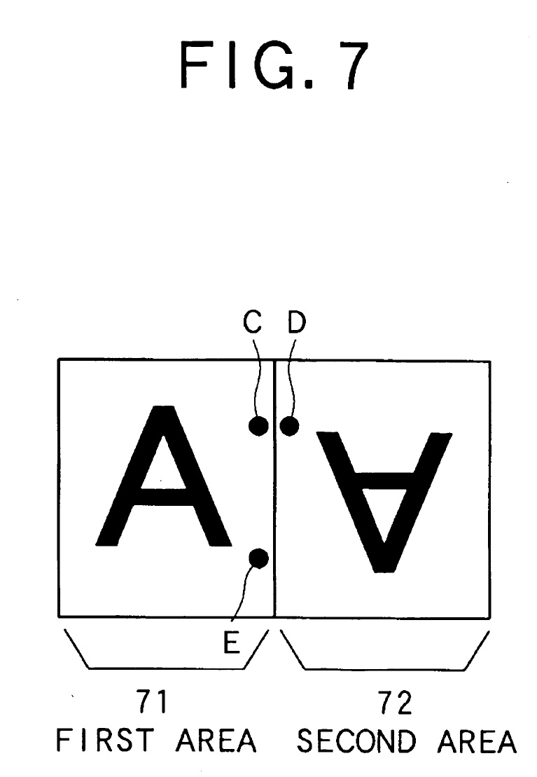

FIGS. 7 to 9 show the second embodiment. The system configuration is identical to that of the first embodiment. Therefore, the description of the common components is omitted by designating them by the common reference numerals.

FIG. 7 is a diagram of the split face-to-face display in the first embodiment. If a D point in a second area 72 is erroneously touched although it has been intended to touch a C point in a first area 72 shown in FIG. 7, the input coordinates from the touch panel 24 are converted like the first embodiment:
X′=Xmax−X;
and
Y′=Ymax−Y.
As a result, the situation is as if the E point were touched, so that the operation is complicated.

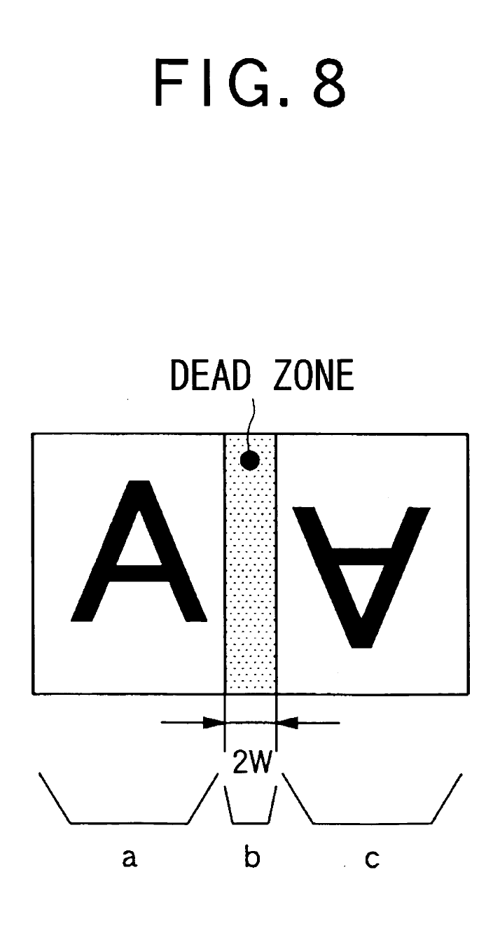

In order to prevent the aforementioned erroneous input in the vicinity of the boundary of the split face-to-face display, therefore, a dead zone is disposed in the boundary between the areas of the split face-to-face display, as shown in FIG. 8.

If the dead zone has a width W with respect to the area of the half screen, its area width is 2 W. In the split face-to-face display, more specifically, area in the horizontal direction from the point of (Xmax/2−W) to a point of (Xmax/2+W), that is, the area having the width of 2 W is the dead zone.

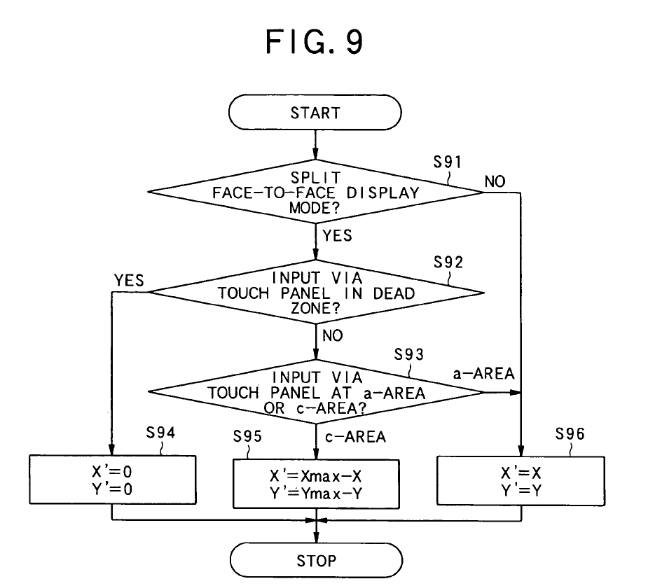

The processing method at this time will be described with reference to the flow chart of FIG. 9. First of all, if an input is done at the touch panel 24, it is decided at S91 whether the mode is in the split face-to-face display mode. The routine advances to S92, if yes, but to S96 if no.

At S92, it is decided whether or not the input from the touch panel 24 is at the dead zone. Specifically, if the input coordinate is Xmax/2−W or larger and Xmax/2+W or less, it is judged that the dead zone area has been touched, and the routine advances to S94. The values X′ and Y′ outputted are both “0” as the information independent of the coordinates of the touch position. If the condition is dissatisfied to give the answer no, the routine advances to S93.

At S93, it is judged whether the input from the touch panel 24 belongs to the a-area or the c-area, as shown in FIG. 8. The routine advances to S96, if the a-area, but to S95 if the c-area. The description of the operations of S95 and S96 is omitted, because they are identical to the processing contents of S83 and s84 of the first embodiment, which have already been described.

For the touch panel input coordinates (X, Y) in the case of the split face-to-face display mode, the output coordinates (X′, Y′) from the touch panel control unit 23 can be summarized in the following;
a) 0≦X≦Xmax/2−W (the a-area of FIG. 8),
   X′=X,
   and
   Y′=Y;
b) Xmax/2−W<X≦Xmax+W (the b-area of FIG. 8),
   X′=0,
   and
   Y′=0; and
c) Xmax/2+W<X≦Xmax (the c-area of FIG. 8),
   X′=Xmax−X,
   and
   Y′=Ymax−Y.

As has been described hereinbefore, the dead zone is disposed between the adjoining split screens at the time of the split face-to-face display mode, and touch inputs on the zone can be ignored and no indefinite designation is reflected on the display screen so that any unintentional operation can be prevented. In this embodiment, like the first embodiment, the conversion of the coordinate information and/or the processing for ignoring the coordinate input at the dead zone area is not performed in the positional information outputting circuit, but the coordinate information of the actual designated position is outputted from the positional information outputting circuit. At the time of a predetermined signal processing in another signal processing circuit, an inhibition control may be made on the processing of the aforementioned coordinate conversion or the predetermined signal processing of the case in which the dead zone area is designated. With another configuration, in case it is recognized that the position in the second area is indicated when the mode is in the split face-to-face display mode, the coordinate information is outputted like the aforementioned mode from the positional information outputting circuit, a signal may be outputted by adding to it the information for performing, after the conversion of the coordinate information, the predetermined signal processing using the signal containing that coordinate information. In case the dead zone area is designated, the coordinate information is outputted from the positional information outputting circuit, a signal may be outputted by adding to it the information for performing the inhibition control of the predetermined processing with the signal containing that coordinate information.

Here, the second embodiment has used the dead zone which adjoins the boundary across the width W from the boundary between the first area and the second area. However, a third area belonging to neither the first area nor the second area may be provided in the portion interposed between the first area and the second area, so that it may be used as the dead zone.

This application claims priority from Japanese Patent Application No.2004-015613 filed Jan. 23, 2004, which is hereby incorporated by reference herein.

1. A positional information outputting device comprising:
a display screen;
a positional information outputting circuit for outputting the coordinate information of a position designated on said display screen; and
an output circuit for outputting a display signal for displaying a first image corresponding to a portion of an image, which can be formed with an image signal inputted, on a first area and a second area of said display screen,
wherein said positional information outputting circuit outputs, in case the inside of said first area on said display screen is designated, the coordinate information on said designated position, and converts, in case the inside of said second area is designated, the coordinate information on said designated position into the coordinate information on the corresponding position in said first area, and outputs the converted coordinate information.

2. A positional information outputting device comprising:
a display screen;
a positional information outputting circuit for outputting the coordinate information of a position designated on said display screen;
an output circuit for outputting a display signal for displaying a first image corresponding to a portion of an image, which can be formed with an image signal inputted, on a first area and a second area of said display screen; and
a control circuit for performing, in case the coordinate information outputted by said positional information outputting circuit is the information indicating that the inside of said first area on said display screen is designated, a predetermined signal processing according to said coordinate information, and for converting, in case the coordinate information outputted by said positional information outputting circuit is the information indicating that the inside of said second area on said display screen is designated, said coordinate information into the coordinate information on the corresponding position in said first area thereby to perform said predetermined signal processing.

3. A positional information outputting method for a positional information outputting device including: a display screen; a positional information outputting circuit for outputting the information of a position designated on said display screen; and an output circuit for outputting a display signal for displaying a first image corresponding to a portion of an image, which can be formed with an image signal inputted, on a first area and a second area of said display screen,
wherein said positional information outputting circuit outputs, in case the inside of said first area on said display screen is designated, the coordinate information on said designated position, and converts, in case the inside of said second area is designated, the coordinate information on said designated position into the coordinate information on the corresponding position in said first area, and outputs the converted coordinate information.

4. A signal processing method for performing a signal processing according to the coordinate information outputted by a positional information outputting device including: a display screen; a positional information outputting circuit for outputting the coordinate information of a position designated on said display screen; and an output circuit for outputting a display signal for displaying a first image corresponding to a portion of an image, which can be formed with an image signal inputted, on a first area and a second area of said display screen,
wherein in case the coordinate information outputted by said positional information outputting circuit is the information indicating that the inside of said first area on said display screen is designated, a predetermined signal processing according to said coordinate information is performed, and
wherein in case the coordinate information outputted by said positional information outputting circuit is the information indicating that the inside of said second area on said display screen is designated, said coordinate information is converted into the coordinate information of the corresponding position in said first area, and said predetermined signal processing is performed.

5. A positional information outputting device comprising:
a display screen;
a positional information outputting circuit for outputting the coordinate information of a position designated on said display screen; and
an output circuit for outputting a display signal for displaying a first image corresponding to a portion of an image, which can be formed with an image signal inputted, on a first area and a second area of said display screen,
wherein said positional information outputting circuit outputs, in case the inside of said first area on said display screen is designated, the coordinate information on said designated position, and converts, in case the inside of said second area is designated, the coordinate information on said designated position into the coordinate information on the corresponding position in said first area, and outputs the converted coordinate information, but does not output, in case either the inside of the area defined by said first area and said second area or the inside of a predetermined area adjoining the boundary between said first area and said second area is designated, the coordinate information on said designated position.

6. A positional information outputting device comprising:
a display screen;
a positional information outputting circuit for outputting the coordinate information of a position designated on said display screen;
an output circuit for outputting a display signal for displaying a first image corresponding to a portion of an image, which can be formed with an image signal inputted, on a first area and a second area of said display screen; and
a control circuit for performing, in case the coordinate information outputted by said positional information outputting circuit is the information indicating that the inside of said first area on said display screen is designated, a predetermined signal processing according to said coordinate information, and for converting, in case the coordinate information outputted by said positional information outputting circuit is the information indicating that the inside of said second area on said display screen is designated, said coordinate information into the coordinate information on the corresponding position in said first area thereby to perform said predetermined signal processing, but for unperforming, in case the coordinate information outputted by said positional information outputting circuit is the information indicating either the inside of the area defined by said first area and said second area or the inside of a predetermined area adjoining the boundary between said first area and said second area, said predetermined signal processing according to said coordinate information.

7. A positional information outputting method for a positional information outputting device including: a display screen; a positional information outputting circuit for outputting the information of a position designated on said display screen; and an output circuit for outputting a display signal for displaying a first image corresponding to a portion of an image, which can be formed with an image signal inputted, on a first area and a second area of said display screen,
wherein said positional information outputting circuit outputs, in case the inside of said first area on said display screen is designated, the coordinate information on said designated position, and converts, in case the inside of said second area is designated, the coordinate information on said designated position into the coordinate information on the corresponding position in said first area, and outputs the converted coordinate information, but does not output, in case either the inside of the area defined by said first area and said second area or the inside of a predetermined area adjoining the boundary between said first area and said second area is designated, the coordinate information on said designated position.

8. A signal processing method for performing a signal processing according to the coordinate information outputted by a positional information outputting device including: a display screen; a positional information outputting circuit for outputting the coordinate information of a position designated on said display screen; and an output circuit for outputting a display signal for displaying a first image corresponding to a portion of an image, which can be formed with an image signal inputted, on a first area and a second area of said display screen,
wherein in case the coordinate information outputted by said positional information outputting circuit is the information indicating that the inside of said first area on said display screen is designated, a predetermined signal processing according to said coordinate information is performed, and
wherein in case the coordinate information outputted by said positional information outputting circuit is the information indicating that the inside of said second area on said display screen is designated, said coordinate information is converted into the coordinate information of the corresponding position in said first area, and said predetermined signal processing is performed, and
wherein in case the coordinate information outputted by said positional information outputting circuit is the information indicating either the inside of the area defined by said first area and said second area or the inside of a predetermined area adjoining the boundary between said first area and said second area, said predetermined signal processing according to said coordinate information is not performed.

9. A positional information outputting device comprising:
a display screen;
a positional information outputting circuit for outputting the coordinate information of a position designated on said display screen;
an output circuit for outputting a display signal for displaying a first image corresponding to a portion of an image, which can be formed with an image signal inputted, on a first area and a second area of said display screen; and
a control circuit for performing, in case the coordinate information outputted by said positional information outputting circuit is the information indicating that the inside of said first area on said display screen is designated, a predetermined signal processing according to said coordinate information, and for converting, in case the coordinate information outputted by said positional information outputting circuit is the information indicating that the inside of said second area on said display screen is designated, said coordinate information into the coordinate information on the corresponding position in said first area thereby to perform said predetermined signal processing, but for inhibiting, in case the coordinate information outputted by said positional information outputting circuit is the information indicating either the inside of the area defined by said first area and said second area or the inside of a predetermined area adjoining the boundary between said first area and said second area, said predetermined signal processing according to said coordinate information.

10. A signal processing method for performing a signal processing according to the coordinate information outputted by a positional information outputting device including: a display screen; a positional information outputting circuit for outputting the coordinate information of a position designated on said display screen; and an output circuit for outputting a display signal for displaying a first image corresponding to a portion of an image, which can be formed with an image signal inputted, on a first area and a second area of said display screen,
wherein in case the coordinate information outputted by said positional information outputting circuit is the information indicating that the inside of said first area on said display screen is designated, a predetermined signal processing according to said coordinate information is performed, and
wherein in case the coordinate information outputted by said positional information outputting circuit is the information indicating that the inside of said second area on said display screen is designated, said coordinate information is converted into the coordinate information of the corresponding position in said first area, and said predetermined signal processing is performed, and
wherein in case the coordinate information outputted by said positional information outputting circuit is the information indicating either the inside of the area defined by said first area and said second area or the inside of a predetermined area adjoining the boundary between said first area and said second area, said predetermined signal processing according to said coordinate information is inhibited.
